(19) United States
(12) Patent Application Publication
(10) Pub. No.: US 2016/0209676 A1
(43) Pub. Date: Jul. 21, 2016

(54) ASSEMBLY STRUCTURE OF SPECTACLE

(71) Applicant: PROHERO GROUP CO., LTD., TAINAN CITY (TW)

(72) Inventor: PEN-WEI CHEN, TAINAN CITY (TW)

(21) Appl. No.: 14/598,419

(22) Filed: Jan. 16, 2015

(51) Int. Cl. G02C 5/22; G02C 5/14; G02C 3/00; G02C 11/02

(52) U.S. Cl. CPC G02C 5/22; G02C 11/02; G02C 5/146; G02C 3/003; G02C 2200/04

(57) ABSTRACT

An assembly structure of spectacle is provided, in which one end of a connecting member of a wearing element (such as a temple) has a cut-out portion, which is fitted with an inverse cut-out portion provided on a frame connector. Each of the connecting member and the frame connector has a bore and an integral guiding slot provided beside the bore. A coupling member having an axle rod and a fixing block is used to couple the connecting member and the frame connector together. By the assembly of the connecting member, the frame connector and the coupling member, user can assemble different style of wearing elements such as temples or strap according to his preference or dressing as required.

### BACKGROUND OF THE INVENTION

1. Field of the Invention

The present invention relates to an assembly structure of spectacle, more particularly to an assembly structure of spectacle formed by a connecting member, a frame connector and a coupling member, by which user can easily assemble different style of a wearing element such as a temple according to required collocation.

2. Brief Description of Prior Arts

As the structure of exercise spectacle is different from ordinary optical eyeglasses and sun glasses, users often purchase exercise eyeglasses having a strap in order to wear it for strenuous dynamic activities. However, in the design of the exercise eyeglasses and the ordinary eyeglasses and the sun glasses, the elements and the functions thereof are almost the same except the difference of arrangement of either a strap or temples. But users have to buy both types of exercise eyeglasses and ordinary eyeglasses, and this not only results in economic burden of users but also the exercise eyeglasses are often idled in the room corner when not in use, resulting in waste of resource.

### SUMMARY OF THE INVENTION

The present invention relates to an assembly structure of spectacle, the main object of this invention is to provide an assembly structure of spectacle formed by a connecting member, a frame connector and a coupling member, by which users are able to change different style of wearing element according to user's collocation needed.

In order to achieve above object, the inventor of the present invention proposes an assembly structure of spectacle, comprising:

a connecting member, the front end of which is formed with a cut-out portion on the inner side surface thereof, and a bore on the other side surface opposite to the cut-out portion; a guiding slot communicating with the bore being provided beside the bore; the bore and the guiding slot being allowed to penetrate to the cut-out portion; and a wearing element such as a temple or a strap being attached to the rear end of the connecting member;

a frame connector formed with a cut-out portion on a side surface opposite to the connecting member so as to engage with the cut-out portion of the connecting member; a bore being provided on the other side surface opposite to the cut-out portion and a guiding slot communicating with the bore being provided beside the bore; the bore and the guiding slot being allowed to penetrate to an appropriate position in the frame connector where a snap-fit groove is formed; the snap-fit groove being made to be communicated with the guiding slot; the snap-fit groove and the guiding slot being further extended over to the cut-out portion; an assembly block being integrally provided on the front end of the frame connector;

a coupling member having a decoration plate and an axle rod provided on the side face opposite to the connecting member; a fixing block being integrally formed beside the end of the axle rod; the axle rod and the fixing block being formed in such a manner that they corresponds to the bores and the guiding slot of the connecting member and the frame connector respectively; the axle rod and the fixing block being inserted through the bores and the guiding slot of the connecting member and the frame connector orderly, and the fixing block provided on the end of the axle rod being allowed to penetrate to the snap-fit groove of the frame connector, and the coupling member being rotated in such a manner that the fixing block is dislocated with respect to the guiding slot of the frame connector and is locked within the snap-fit groove, and the decoration plate is in registry with the connecting member.

### BRIEF DESCRIPTION OF ACCOMPANYING DRAWINGS

The present invention will be better understood by the detailed description of preferred embodiments with reference to the accompanied drawings, in which:

FIG. 1 is a perspective exploded view of a first embodiment of the present invention;

FIG. 2 is a first perspective assembly view of the first embodiment of the present invention;

FIG. 3 is a second perspective assembly view of the first embodiment of the present invention;

FIG. 4 is a sectional view of the first embodiment of the present invention;

FIG. 5 is a first view of the first embodiment of the present invention in use state;

FIG. 6 is a second view of the first embodiment of the present invention in use state;

FIG. 7 is a perspective exploded view of a second embodiment of the present invention;

FIG. 8 is a perspective assembly view of the second embodiment of the present invention.

### DETAILED DESCRIPTION OF PREFERRED EMBODIMENTS

The technical contents, objects and effect of the present invention will become more apparent by the detailed description in conjunction with the accompanied drawings.

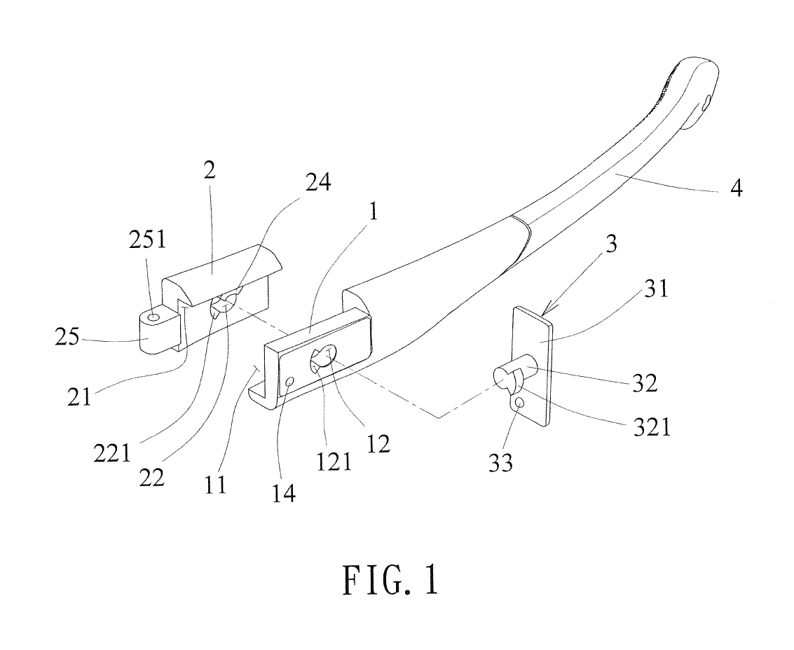

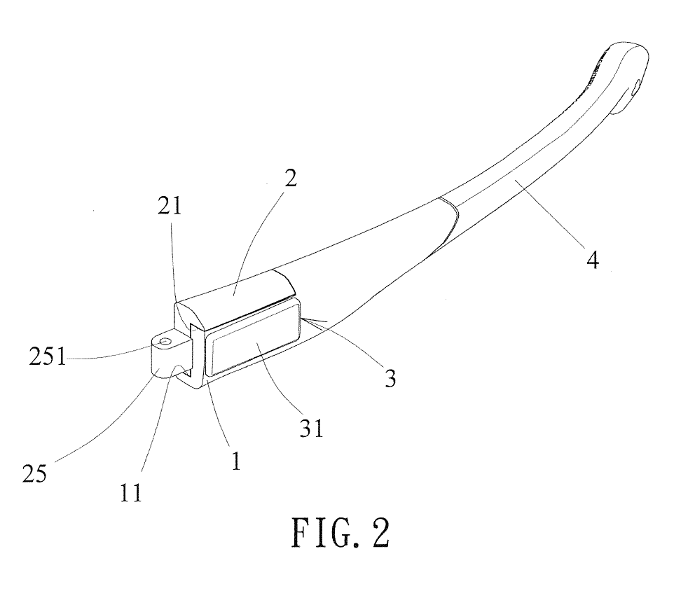

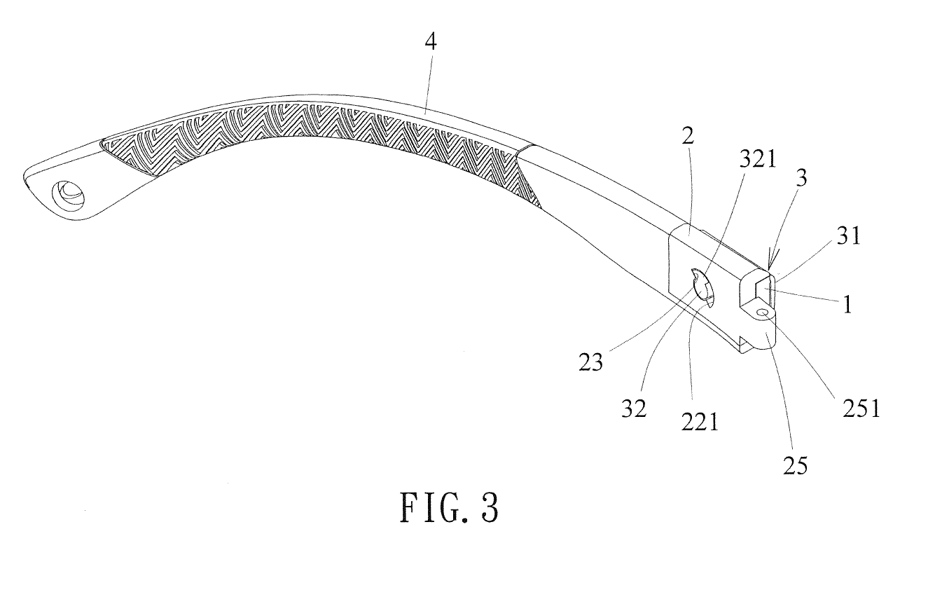

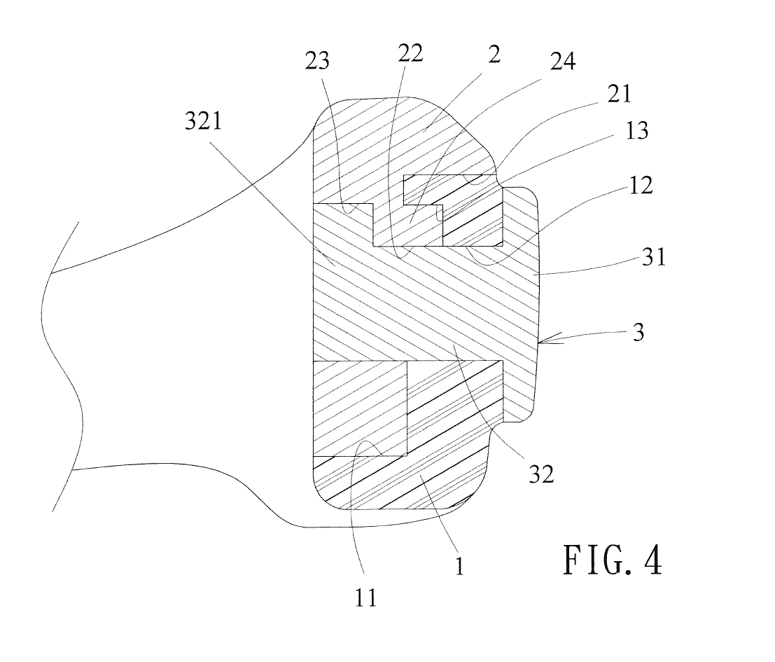

Firstly referring to FIG. 1 to FIG. 4, the assembly structure of spectacle of a first embodiment of the present invention is mainly formed by a connecting member (1), a frame connector (2) and a coupling member (3).

The connecting member (1) is formed with an L shape cut-out portion (11) on the inner side surface, and a bore (12) on the other side surface opposite to the cut-out portion (11). A guiding slot (121) communicating with the bore (12) is provided beside the bore (12). The bore (12) and the guiding slot (121) are allowed to penetrate to the cut-out portion (11). Further, a locating groove (13) is provided on an end face of the L shape cut-out portion (11), and a locating hole (14) is provided on the other end face opposite to the cut-out portion (11). A wearing element such a temple (4) is attached to the rear end of the connecting member (1).

The frame connector (2) is formed with an inverse L shape cut-out portion (21) which corresponds to the L shape cut-out portion (11) of the connecting member (1) and engages therewith when in assembly process. A bore (22) is provided on the other side surface opposite to the inverse L shape cut-out portion (21), and a guiding slot (221) communicating with the bore (22) is provided beside the bore (22). The bore (22) and the guiding slot (221) are allowed to penetrate to an appropriate position in the frame connector (2), where a snap-fit groove (23) is formed. Furthermore, the snap-fit groove (23) is made to be communicated with the guiding slot (221); the snap-fit groove (23) and the guiding slot (221) are further extended over to the inverse L shape cut-out portion (21). A locating portion (24) is provided on the end face of the inverse L shape cut-out portion (21), and the locating portion (24) engages with the locating groove (13) provided on the end face of the L shape cut-out portion (11) when the inverse L shape cut-out portion (21) of the frame connector (2) fits with the L shape cut-out portion (11) of the connecting member (1). Further, an assembly block (25) is integrally provided on the front end of the frame connector (2) and a pivot hole (251) is provided on the assembly block (25).

The coupling member (3) has a decoration plate (31) and an axle rod (32) is provided on the side face opposite to the connecting member (1). A fixing block (321) is integrally formed beside the end of the axle rod (32). The axle rod (32) and the fixing block (321) are formed in such a manner that they corresponds to the bores (12), (22) and the guiding slots (121), (221) of the connecting member (1) and the frame connector (2) respectively. Further, the axle rod (32) and the fixing block (321) are inserted through the bores (12), (22) and the guiding slots (121), (221) of the connecting member (1) and the frame connector (2) orderly, and the fixing block (321) provided on the end of the axle rod (32) is allowed to penetrate to the snap-fit groove (23) of the frame connector (2). Then, the coupling member (3) is rotated such that the fixing block (321) is dislocated with respect to the guiding slot (221) of the frame connector (2) and is locked and positioned within the snap-fit groove (23). At this moment, the decoration plate (31) is in registry with the connecting member in such a manner that a locating protrusion (33) provided on the side face opposite to the connecting member (1) is engaged with the locating hole (14) provided on the connecting member (1) for positioning. Moreover, the decoration plate (31) is provided with a trade mark plate labeled by at least one of characters and patterns on the other side face opposite to the axle rod (32).

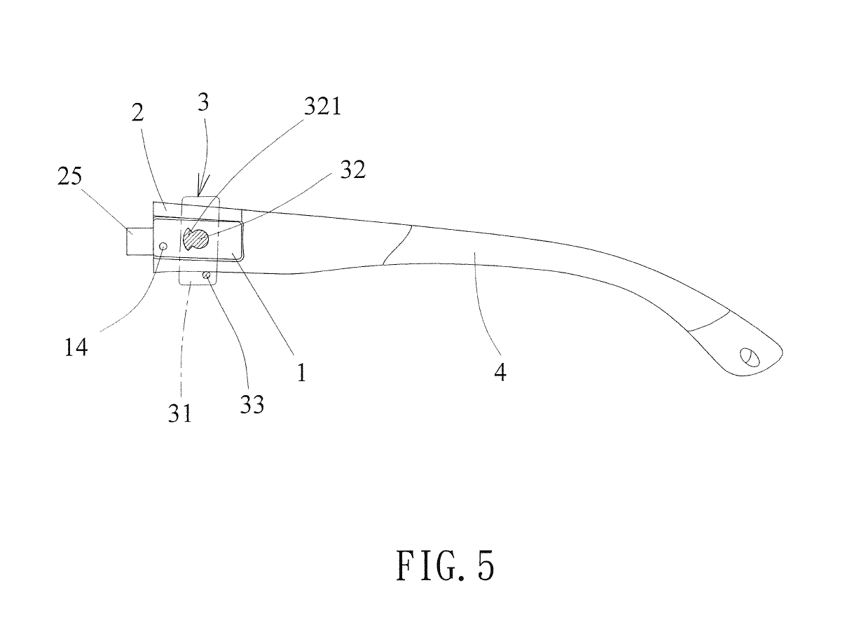

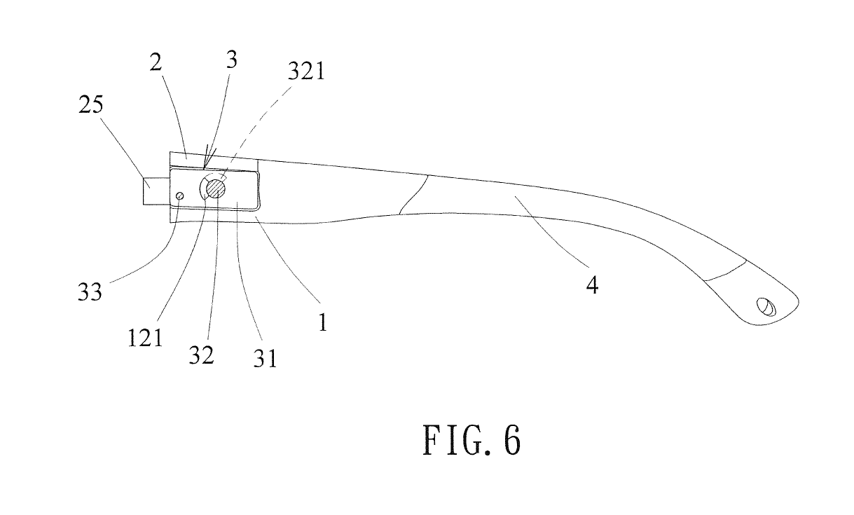

In this manner, when in assembly operation, the wearing element such as a temple according to the present invention is assembled on an eyeglass frame by penetrating a pivot through the pivot hole (25) on the assembly block (25) of the frame connector (2) aligned with a pivot hole on a seat fixed on each side of the eyeglass frame, as shown in FIG. 5. Next, the L shape cut-out portion (11) of the connecting member (1) is fitted with the inverse L shape cut-out portion (21) of the frame connector (2). Then, the axle rod (32) and the fixing block (321) of the coupling member (3) are inserted, from the side face of the connecting member (1) other than that abutted with the frame connector (2), through the bores (12), (22) and the guiding slots (121),(221) of the connecting member (1) and the frame connector (2) orderly, and the fixing block (321) is rotated a certain angle, as shown in FIG. 6, after reaching the guiding slot (221) of the frame connector (2) such that the fixing block (321) is dislocated with respect to the guiding slot (221) of the frame connector (2) and is locked and positioned within the snap-fit groove (23) of the frame connector (2). At the same time, the locating protrusion (33) on the decoration plate (31) is engaged in the locating hole (14) of the connecting member (1) so that the decoration plate (31) is aligned orderly with the connecting member (1). In this manner, the assembly of the wearing element (in this case, a temple) of the present invention is accomplished.

When a user want to make costume collocation by changing temples with different shape, color and texture, the coupling member (3) is rotated so that the fixing block (321) of the coupling member (3) is in registry with the guiding slot (221) of the frame connector (2). Then, the axle rod (32) and the fixing block (321) of the coupling member (3) can be withdrawn out through the bores (12), (22) and the guiding slots (121),(221) of the connecting member (1) and the frame connector (2) orderly, so that the connecting member (1) can be separated from the frame connector (2) completely. In turn, user can substitute a new temple with his favorite shape, color and texture for old one and assemble the connecting member (1) on the frame connector (2) by the coupling member (3) according to the abovementioned assembly method. Thus, the user can assemble different style of temples (4) according to his preference or dressing as required, so as to improve him with a unique sense of dress-up and fashion. At the same time, the user can deprive of the economic burden of purchasing a plurality of eyeglasses and thus the inconvenience of storage after purchasing a plurality of eyeglasses. Furthermore, for the eyeglasses industries is concerned, to provide such an assembly structure of spectacle in line with consumer market can achieve the effectiveness of attracting more consumers to buy so as to improve the market sales. The assembly structure of spectacle of the present invention can be provided to all brands eyeglasses sales company for selling by merely replace the coupling member labeled with trademark characters and patterns thereon. Thus, this can enhance its competitiveness in concerned business.

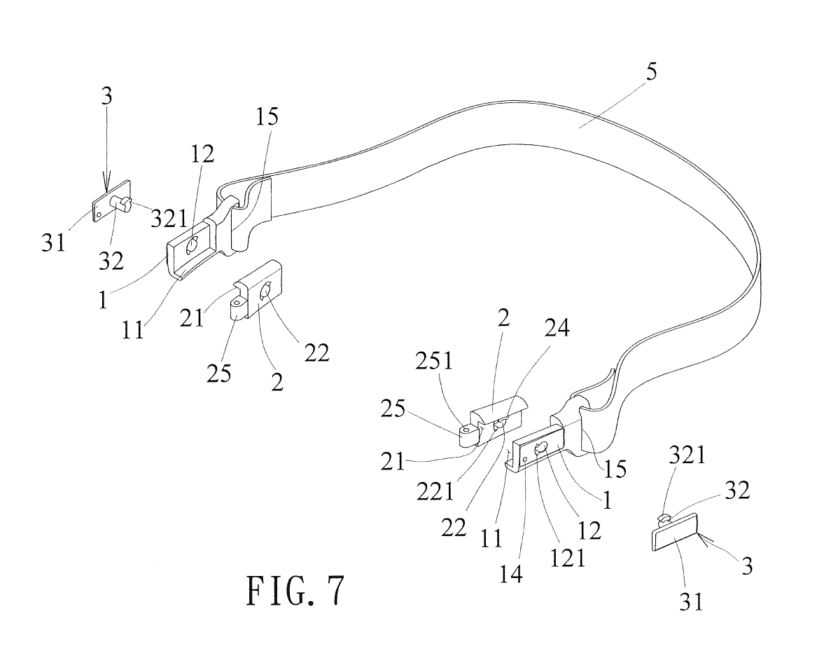

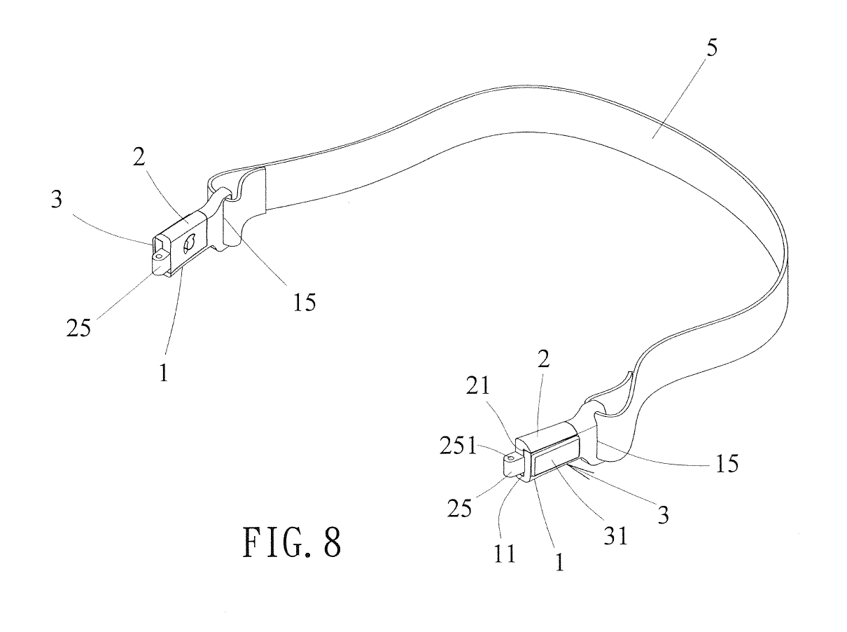

FIG. 7 and FIG. 8 show a second embodiment of the assembly structure of spectacle of the present invention. The present invention can also be applied in the case that the wearing element assembled at the rear end of the connecting member (1) is a strap (5). In this case, perforations (15) are respectively formed on both connecting members (1) of the present invention so that the strap (5) can combine its two ends in the perforations (15). In this way, when a user want to conduct dynamic activities such as jogging or jumping exercise, the user merely replaces the connecting members (1) having the temples (4) attached to their rear ends with the connecting members (1) having a strap (5) tied thereto, and then assembles the connecting members (1) on the frame connectors (2) by the coupling members (3) according to the abovementioned procedure, the user can wear the eyeglasses with the strap tying on the head to conduct strenuous dynamic activities. In this manner, user can change flexibly the wearing elements such as temples (4) or a strap (5) according to his personal needs without spending extra money to buy two types of eyeglasses. Not only economic burden of purchasing both types of eyeglasses can be reduced but also material resource can be effectively employed by exploit only one eyeglasses as exercise eyeglasses or ordinary eyeglasses.

1-10. (canceled)

11. An assembly structure of spectacle, comprising:
a connecting member formed with an L shape cut-out portion on an inner side surface thereof, and a bore on the other side surface opposite to the L shape cut-out portion; a guiding slot communicating with the bore being provided beside the bore; the bore and the guiding slot extending through the connecting member to the L shape cut-out portion; and a wearing element being attached to the rear end of the connecting member;
a frame connector formed with an inverse L shape cut-out portion on a side surface opposite to the connecting member to correspond and fit with the L shape cut-out portion of the connecting member; a bore being provided on the other side surface opposite to the inverse L shape cut-out portion of the frame connector and a guiding slot communicating with the bore being provided beside the bore; the bore and the guiding slot extending into the frame connector where a snap-fit groove is formed; the snap-fit groove communicating with the guiding slot; the snap-fit groove and the guiding slot being extended to the inverse L shape cut-out portion of the frame connector; an assembly block being integrally provided on a front end of the frame connector; and
a coupling member having a decoration plate and an axle rod provided on a side face opposite to the connecting member; a fixing block being integrally formed at an end of the axle rod;
the axle rod and the fixing block being inserted through the bores and the guiding slots of the connecting member and the frame connector orderly, with the fixing block being rotated to retentively engage the snap-fit groove of the frame connector upon the coupling member being rotated to be locked in angular position with respect to the connecting member, the decoration plate being thereby aligned with the connecting member;
wherein the connecting member has a locating hole provided on the side face opposite to the side face of the L shape cut-out portion, and the coupling member has a locating protrusion provided on the side face formed with the axle rod of the coupling member so as to engage in the locating hole of the connecting member for positioning.

12. The assembly structure of spectacle as claimed in claim 11, wherein the decoration plate provided on the coupling member is labeled with at least one of characters and patterns on the other side face opposite to the axle rod.

13. The assembly structure of spectacle as claimed in claim 11, wherein the frame connector has a pivot hole provided on the assembly block.

14. The assembly structure of spectacle as claimed in claim 11, wherein the end face of the cut-out portion of the connecting member and the end face of the cut-out portion of the frame connector are respectively formed with a locating groove and a locating portion matching and engaging with each other for positioning.

15. The assembly structure of spectacle as claimed in claim 11, wherein the wearing element is a temple.

16. The assembly structure of spectacle as claimed in claim 15, wherein the rear end of the connecting member is integrally connected with the temple.

17. The assembly structure of spectacle as claimed in claim 11, wherein the wearing element is a strap.

18. The assembly structure of spectacle as claimed in claim 17, wherein the rear end of each connecting member is formed with a perforation for fastening one end of the strap.
